(19) United States
(12) Patent Application Publication
(10) Pub. No.: US 2021/0294988 A1
(43) Pub. Date: Sep. 23, 2021

(54) Machine Translation of Digital Content

(71) Applicant: Citrix Systems, Inc., Fort Lauderdale, FL (US)

(72) Inventors: Hao Wu, Nanjing (CN); Yu Xin, Nanjing (CN); Maohui Wu, Nanjing (CN); Bo Zang, Nanjing (CN)

(21) Appl. No.: 16/887,492

(22) Filed: May 29, 2020

Related U.S. Application Data
(63) Continuation of application No. PCT/CN20/79962, filed on Mar. 18, 2020.

(51) Int. Cl. G06F 40/58; G06N 20/00; H04L 12/26; G06F 40/51; G06F 40/55

(52) U.S. Cl. CPC G06F 40/58; G06N 20/00; G06F 40/55; G06F 40/51; H04L 43/16

(57) ABSTRACT

Methods and systems for determining text for translation are described herein. A client device may receive a content item containing text and a user may need to have only some of the text translated. The client device may cause subsets of the text to be translated. The client device may use translation data that may indicate which subsets of text within a content item should be translated and one or more target languages to translate the text into. The translation data may contain user preferences indicating which text portions a particular user desires to be translated. The translation data may be created and modified using machine learning. A machine learning model may learn which text portions should be translated based on what users have requested to be translated in the past and may determine which text portions of a content item should be translated.

### CROSS REFERENCE TO RELATED APPLICATIONS

This application claims priority to International Application No. PCT/CN20/79962, filed Mar. 18, 2020, and entitled “Machine Translation of Digital Content,” which is hereby incorporated by reference in its entirety.

### FIELD

Aspects described herein generally relate to computing and machine translation, and hardware and software related thereto. More specifically, one or more aspects described herein are directed towards translation of digital content.

### BACKGROUND

Machine translation may be used to translate text from one language to another. Machine translation may be performed by a client-server system in which the client sends text to the server to translate. A user may select a target language that a user desires text to be translated into.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed towards machine translation of digital content. Instead of translating an entire document or webpage, a user may need only a portion of the text to be translated. A client device may receive a content item containing text and a user may select a portion of the text to be translated. The client device may cause portions of the text to be translated locally or remotely. The client device may use a translation policy that may indicate which portions of text within a content item should be translated and one or more target languages to translate the text into. The policy may contain user preferences indicating which text portions a particular user desires to be translated. Additionally, a user may indicate, via a user interface, which text portions should be translated. The translation policy may be created and modified using machine learning. A machine learning model may learn which text portions should be translated based on what users have requested to be translated in the past. A device may determine which text portions of a content item should be translated.

In one aspect, a computer implemented method may include receiving, by a computing device, content of a webpage, the content including text in a first language; determining, by the computing device, a subset of text of the received content to translate into a second language different from the first language based on a location of the subset of text within the webpage and an identifier of the subset of text, the identifier indicates that portion of text of the received content in which to translate; translating, by the computing device, the determined subset of text into a second language; and providing, by the computing device, the translated subset of text for display within a browser of the computing device so that a portion of the webpage that is of interest to a user of the computing device appears translated in the second language. The subset of text may be determined based on preferences of the user.

The method may further include receiving user input indicating a second subset of text of the received content to translate into the second language; and updating the user preferences based on the user input.

The method may further include receiving user input indicating a second subset of text of the received content to translate into the second language; and generating, based on the user input, training data for use in a machine learning model for determining text to translate.

The translating may include: based on determining that a network connection quality fails to satisfy a threshold, translating the subset of text by the computing device. The translating may include: based on determining that a network connection quality satisfies a threshold, sending the subset of text to a server for translation.

The method may further include determining, based on user input, the second language from a plurality of languages, wherein the plurality of languages are indicated by translation preference data associated with the user.

In one aspect, a computer implemented method may include receiving, by a computing device, content of a webpage, the content including text in a first language; determining, by the computing device, a subset of text of the received content to translate into a second language different from the first language based on output from a machine learning model, the output indicates a location of the subset of text within the webpage; translating, by the computing device, the determined subset of text into a second language; and providing, by the computing device, the translated subset of text for display within a browser of the computing device so that a portion of the webpage that is of interest to a user of the computing device appears translated in the second language. The subset of text may be determined based on preferences of the user.

The method may further include receiving user input indicating a second subset of text of the received content to translate into the second language; and updating translation preference data based on the user input. The method may further include receiving user input indicating a second subset of text of the received content to translate into the second language; and generating, based on the user input, training data for training the machine learning model to determine text to translate.

The translating may include: based on determining that a network connection quality fails to satisfy a threshold, translating the subset of text by the computing device. The translating may include: based on determining that a network connection quality satisfies a threshold, sending the subset of text to a server for translation.

In other aspects, a system may be configured to perform one or more aspects and/or methods described herein. In some aspects, an apparatus may be configured to perform one or more aspects and/or methods described herein. In some aspects, one or more computer readable media may store computer executed instructions that, when executed, configure a system to perform one or more aspects and/or methods described herein. These and additional aspects will be appreciated with the benefit of the disclosures discussed in further detail below. These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative cloud-based system architecture that may be used in accordance with one or more illustrative aspects described herein.

FIG. 4 depicts an illustrative machine translation system that may be used in accordance with one or more illustrative aspects described herein.

FIG. 5 depicts an illustrative translation policy that may be used in accordance with one or more illustrative aspects described herein.

FIG. 6 depicts an illustrative flow diagram for determining text for translation that may be used in accordance with one or more illustrative aspects described herein.

FIG. 7 depicts an illustrative user interface in which text is translated using the machine translation system of the present disclosure in accordance with one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect connecting and coupling.

Computing Architecture

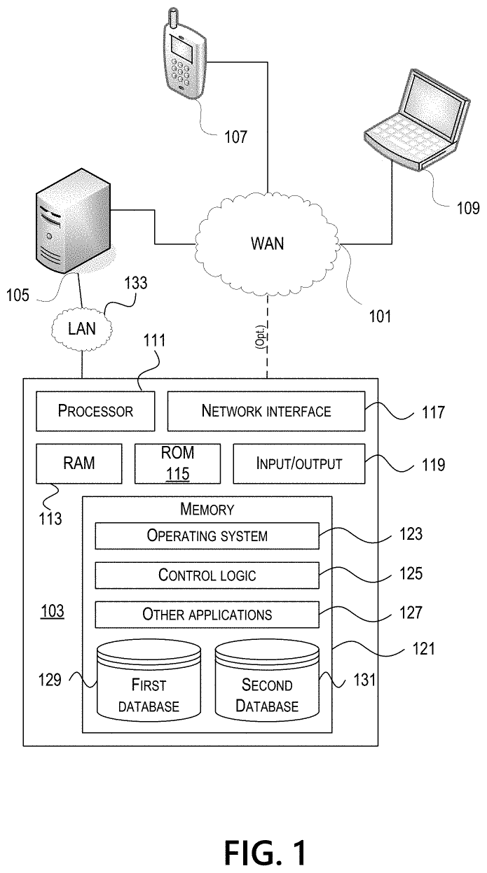

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

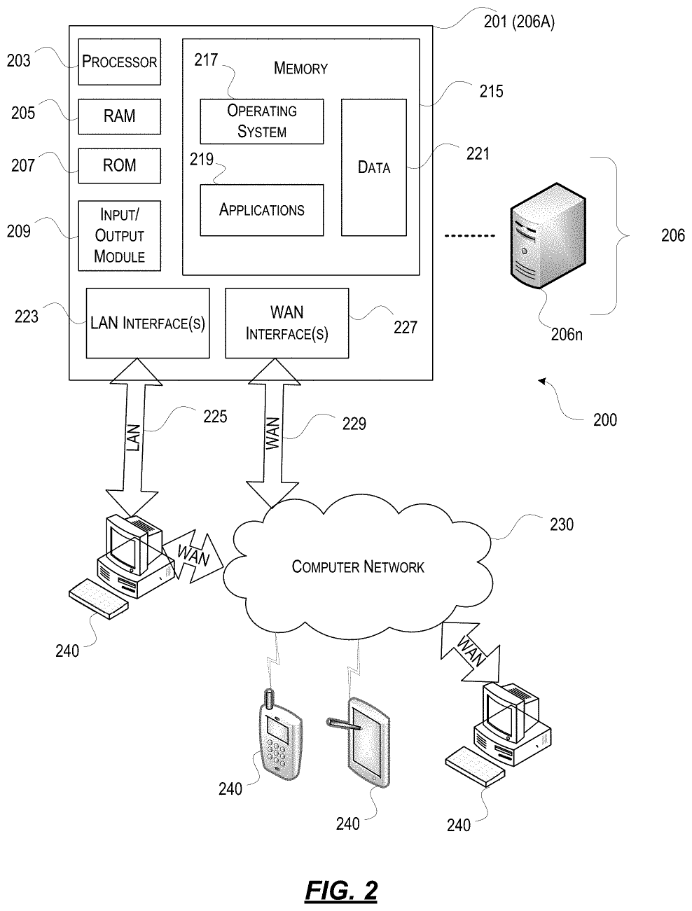

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Fla.; or the Remote Desktop Protocol (RDP) manufactured by the Microsoft Corporation of Redmond, Wash.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

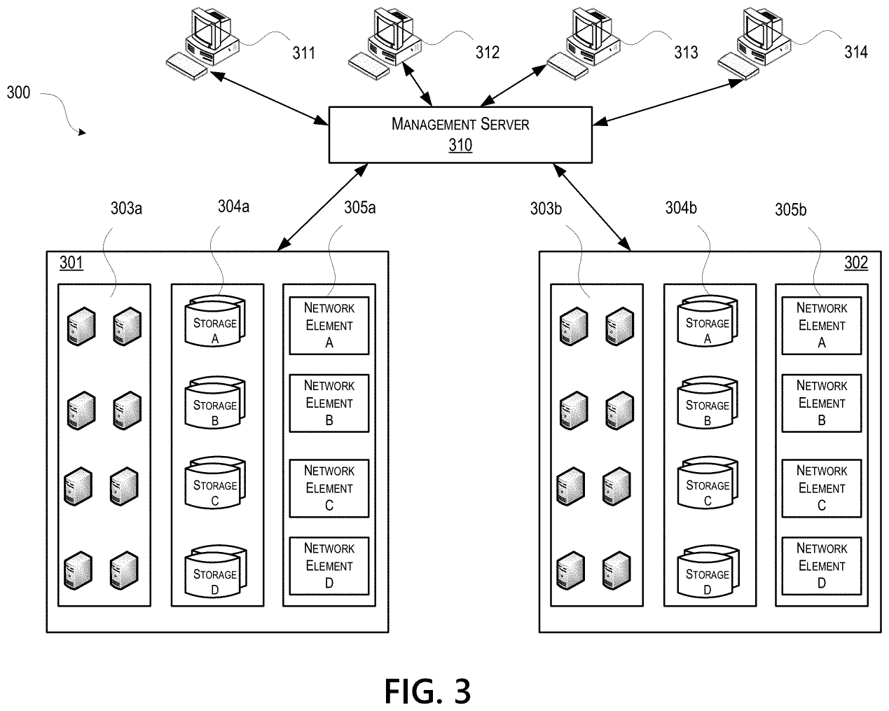

With further reference to FIG. 3, some aspects described herein may be implemented in a cloud-based environment. FIG. 3 illustrates an example of a cloud computing environment (or cloud system) 300. As seen in FIG. 3, client computers 311-314 may communicate with a cloud management server 310 to access the computing resources (e.g., host servers 303a-303b (generally referred herein as “host servers 303”), storage resources 304a-304b (generally referred herein as “storage resources 304”), and network elements 305a-305b (generally referred herein as “network resources 305”)) of the cloud system.

Management server 310 may be implemented on one or more physical servers. The management server 310 may run, for example, Citrix Cloud by Citrix Systems, Inc. of Ft. Lauderdale, Fla., or OPENSTACK, among others. Management server 310 may manage various computing resources, including cloud hardware and software resources, for example, host computers 303, data storage devices 304, and networking devices 305. The cloud hardware and software resources may include private and/or public components. For example, a cloud may be configured as a private cloud to be used by one or more particular customers or client computers 311-314 and/or over a private network. In other embodiments, public clouds or hybrid public-private clouds may be used by other customers over an open or hybrid networks.

Management server 310 may be configured to provide user interfaces through which cloud operators and cloud customers may interact with the cloud system 300. For example, the management server 310 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 310 also may include a set of APIs and/or one or more customer console applications with user interfaces configured to receive cloud computing requests from end users via client computers 311-314, for example, requests to create, modify, or destroy virtual machines within the cloud. Client computers 311-314 may connect to management server 310 via the Internet or some other communication network, and may request access to one or more of the computing resources managed by management server 310. In response to client requests, the management server 310 may include a resource manager configured to select and provision physical resources in the hardware layer of the cloud system based on the client requests. For example, the management server 310 and additional components of the cloud system may be configured to provision, create, and manage virtual machines and their operating environments (e.g., hypervisors, storage resources, services offered by the network elements, etc.) for customers at client computers 311-314, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 311-314 may be related, for example, to different client computers creating virtual machines on behalf of the same end user, or different users affiliated with the same company or organization. In other examples, certain clients 311-314 may be unrelated, such as users affiliated with different companies or organizations. For unrelated clients, information on the virtual machines or storage of any one user may be hidden from other users.

Referring now to the physical hardware layer of a cloud computing environment, availability zones 301-302 (or zones) may refer to a collocated set of physical computing resources. Zones may be geographically separated from other zones in the overall cloud of computing resources. For example, zone 301 may be a first cloud datacenter located in California, and zone 302 may be a second cloud datacenter located in Florida. Management server 310 may be located at one of the availability zones, or at a separate location. Each zone may include an internal network that interfaces with devices that are outside of the zone, such as the management server 310, through a gateway. End users of the cloud (e.g., clients 311-314) might or might not be aware of the distinctions between zones. For example, an end user may request the creation of a virtual machine having a specified amount of memory, processing power, and network capabilities. The management server 310 may respond to the user's request and may allocate the resources to create the virtual machine without the user knowing whether the virtual machine was created using resources from zone 301 or zone 302. In other examples, the cloud system may allow end users to request that virtual machines (or other cloud resources) are allocated in a specific zone or on specific resources 303-305 within a zone.

In this example, each zone 301-302 may include an arrangement of various physical hardware components (or computing resources) 303-305, for example, physical hosting resources (or processing resources), physical network resources, physical storage resources, switches, and additional hardware resources that may be used to provide cloud computing services to customers. The physical hosting resources in a cloud zone 301-302 may include one or more computer servers 303, such as the virtualization servers 301 described above, which may be configured to create and host virtual machine instances. The physical network resources in a cloud zone 301 or 302 may include one or more network elements 305 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 301-302 may include storage disks (e.g., solid state drives (SSDs), magnetic hard disks, etc.) and other storage devices.

The example cloud computing environment shown in FIG. 3 also may include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 303 with the physical computing resources. Known cloud systems may alternatively be used, e.g., WINDOWS AZURE (Microsoft Corporation of Redmond Wash.), AMAZON EC2 (Amazon.com Inc. of Seattle, Wash.), IBM BLUE CLOUD (IBM Corporation of Armonk, N.Y.), or others.

Machine Translation of Digital Content

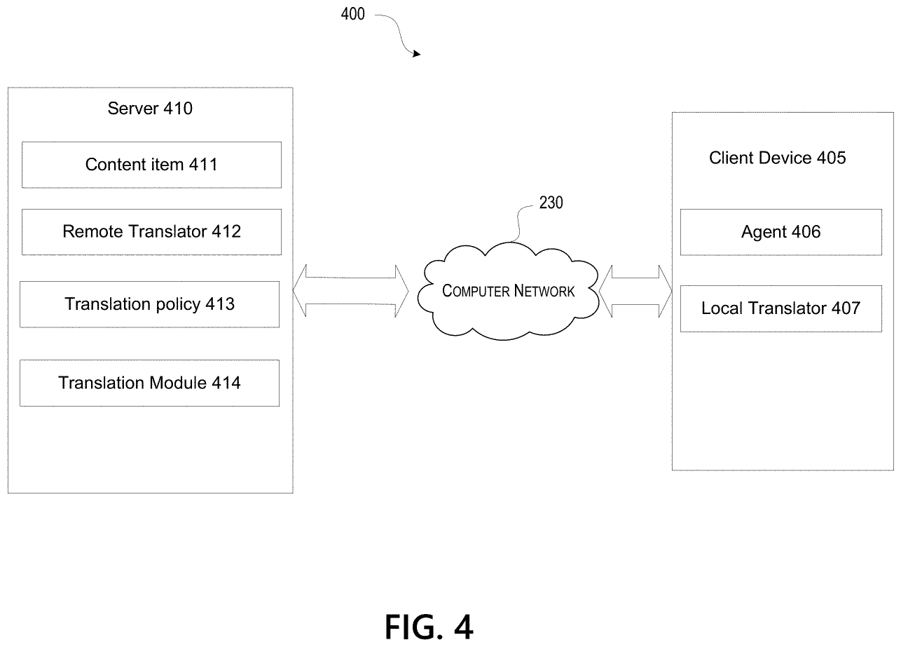

FIG. 4 depicts an illustrative machine translation system 400 that may be used in accordance with one or more illustrative aspects described herein. A server 410 may be in communication with a client device 405 via the computer network 230. Although only the server 410 and the client device 405 are shown in FIG. 4, multiple servers and client devices may be included in the machine translation system 400. The server 410 may be one of or a combination of any of the host servers 303a-303b, the management server 310, any of the servers 206, or any other device discussed in FIGS. 1-3. The client device 405 may be any one of the client computers 311-314, the client 240, devices 103, 105, 107, and 109, or any other device discussed in FIGS. 1-3.

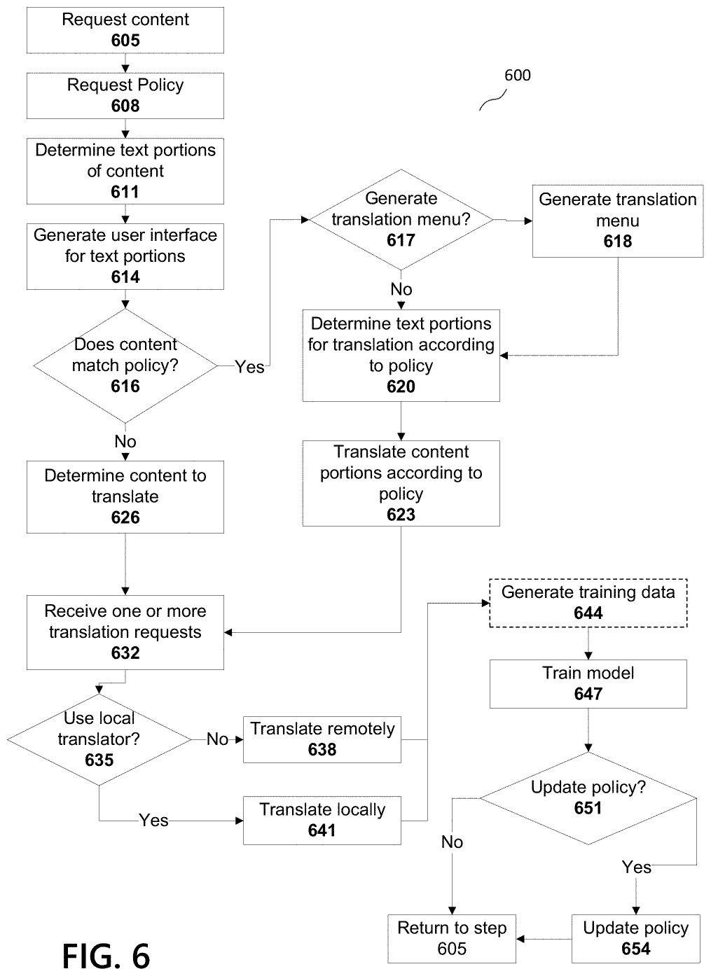

The server 410 may include one or more content items (e.g., content item 411). The content items may be websites, articles, blog posts, videos, or any other type of content that may contain text. The content items may be stored in the server 410 and/or they may be stored remotely. The server 410 may include a remote translator 412 (e.g., it is remote from the client device 405). The remote translator 412 may be configured to receive, from the client device 405, data containing text as input and translate the text into one or more languages (e.g., French, Spanish, Chinese, Italian, Portuguese, Japanese, Korean, Russian, or any other language). The remote translator 412 may receive the text for translation from the client device 405. The remote translator 412 may use machine translation techniques (e.g., techniques using machine learning/artificial intelligence) to translate the text. The remote translator 412 may translate all or a portion (e.g., a proper subset) of the text contained in the content item 411. A proper subset of the text may include some but not all of the text in the content item 411. Multiple proper subsets might be defined. On one example, one proper subset of the text in the content item 411 includes no overlapping text portions with a second proper subset of the text in the content item 411. For example, if the content item 411 contains non-overlapping text portions A, B, and C, the translator 412 may translate a first proper subset containing the text portion A and may leave a second proper subset containing the text portions B and C untranslated. A proper subset of text may be determined by parsing the text contained within the content item 411. A proper subset may include a paragraph, a sentence, a section of a document, or one or more words, etc. Determining text portions within a content item is discussed in more detail below in step 611 of FIG. 6. As an additional example, a user might be interested in reading only one paragraph in a webpage. The paragraph (or subset of text) that the user is interested in may be translated while all other text in the webpage may be left untranslated.

Although described as being part of the server 410, the remote translator 412 may be separate from the server 410 (e.g., it may be its own server or may be part of a third-party server that is provided as a service). The server 410 may provide one or more content items 411 to the client device 405.

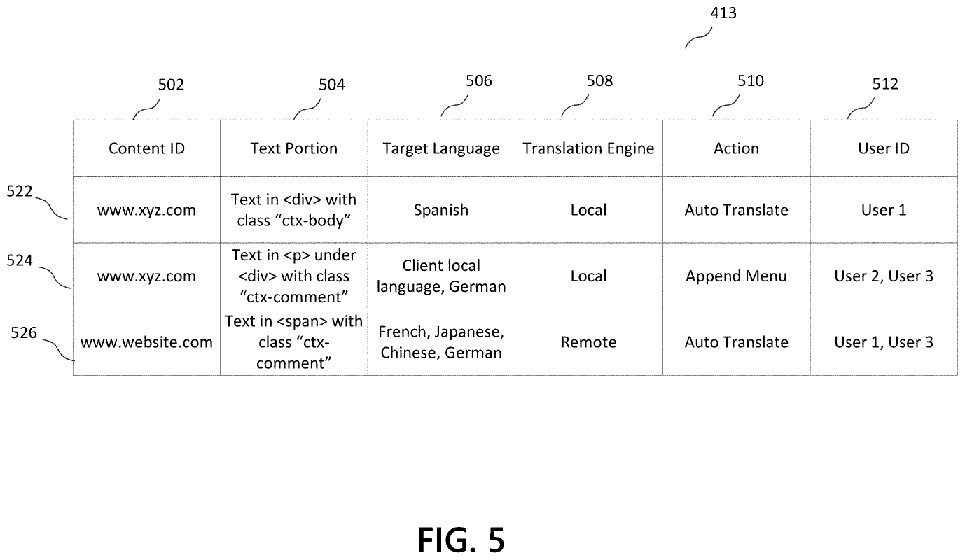

The translation policy 413 may indicate what portions of text of a content item should be translated by the remote translator 412 or local translator 407. The translation policy 413 is described in more detail in connection with FIG. 5. Referring to FIG. 5, the translation policy 413 may include a set of rules (e.g., rules 522-526) that indicate details for translation for a content item and/or for a user. Although only rules 522-526 are shown in FIG. 5, the translation policy 413 may contain any number of rules for any number of content items and/or any number of users. Individual rules may indicate a content identification (ID) 502, a text portion 504, a target language 506, a translation engine 508, an action 510, and/or a user 512. The content ID 502 may identify a content item (e.g., the content item 411) that the rule should be applied to. For example, the content ID 502 may be a uniform resource locator (URL) for a website. The text portion 504 may indicate what portions of text from the content ID 502 should be translated. For example, the text portion 504 may indicate that text between <div> tags that are labeled with a particular class (e.g., “ctx-body”) should be translated. The text portion 504 may indicate that text at a particular location within the content item should be translated. For example, the text portion 504 may indicate that captions for pictures should be translated, titles within the content item should be translated, first and last sentences of paragraphs should be translated, and/or first and last paragraphs within a section of text should be translated.

The target language 506 may indicate one or more languages into which the text indicated by the text portion 504 should be translated. The translation engine 508 may indicate which translator to use (e.g., the local translator 407 or the remote translator 412). The local translator 407 may be used to translate text when a network connection fails to satisfy a connection quality threshold (e.g., low bandwidth, throughput, signal strength, etc.). The action 510 may indicate an action to take on the text indicated by text portion 504. For example, the action 510 may indicate that the text should be translated without waiting for the user to provide input (e.g., auto translate). The action 510 may indicate that a translation menu should be added near the text (e.g., append menu). The translation menu may allow a user to select a language to translate the text into (e.g., text that is adjacent to the translation menu). The translation menu may be helpful when there are more than one target languages to translate into. For example, rule 524 indicates that the target language 506 may be the local language of the client device 405 (e.g., the language spoken in the geographical location of the client device 405) or German. The user ID 512 may indicate a user (e.g., user ID) that the rule applies to. For example, in rule 522, the user ID 512 indicates that the rule applies to user 1. The user ID may indicate a username or any other information that may identify a user. The user ID 512 may indicate multiple users that the rule applies to.

The translation policy 413 may indicate translation preferences for one or more users. For example, the translation policy may indicate what languages a user prefers text of a particular type (e.g., news articles, picture captions, titles, blogs, etc.) to be translated into. The translation policy 413 may indicate that text should be translated based on demographic information of a user (e.g., text should be translated into a particular language for users below an age threshold). The output may indicate that users in a first geographic location (e.g., neighborhood, city, state, county, country, zip code, etc.) prefer some portions of text to be translated while users in a second geographic location prefer other portions of text to be translated. One or more aspects of the translation policy 413 may be combined. For example, the translation policy 413 may indicate that text should be translated into a language for users above an age threshold in a particular geographic location (e.g., country). For example, older users may prefer a language (e.g., a dialect of a language) that some younger users in a country do not speak. The translation policy 413 may indicate that text should be translated into the language for the older users.

A copy of the translation policy 413 may be stored on the client device 405. The client device 405 may update the translation policy based on input from a user of the client device 405. For example, a user may indicate that a portion of text should be translated to a particular language in a content item. The client device 405 may update the translation policy 413 to indicate that the portion of text should be translated. After updating the translation policy 413, the client device 405 may send the updated translation policy 413 to the server 410 for storage.

Referring back to FIG. 4, the server 410 may include a translation module 414. The module 414 may determine which portions of a content item should be translated. The module 414 may determine which portions of a content item to translate based on a popularity aspect of the text portions (e.g., requests from users to translate a text portion are above or satisfy a predetermined threshold). For example, if a first text portion has received more requests for translation than other portions of text the translation policy may be updated so the first text portion is automatically translated. The translation module 414 may use machine learning techniques to determine which text portions should be translated. The module 414 may use training data to make adjustments to one or more machine learning models to improve determinations of which text portions should be translated. The training data may include data corresponding to a text portion of a content item and an indication of whether the text portion should be translated or not. The training data may include data indicating a location of the text portion within the document, the type of content item (e.g., news article, legal document, shopping webpage etc.), whether a user requested the text portion to be translated or not, an indication of the number of users that requested the text portion to be translated (e.g., a fraction with the number of users that requested the text portion to be translated in the numerator and the number of users that viewed the content item in the denominator). A machine learning model used by the module 414 may be trained to determine which text portions should be translated in a content item. The determinations made by the translation module 414 may be used to generate or update a translation policy 413. The translation module 414 is discussed in more detail below in connection with steps 644-654 in FIG. 6.

The client device 405 may be responsible for overseeing translation of portions of the content item 411 and making sure that the translation policy 413 is followed. The client device 405 may receive the content item 411 and the translation policy 413 from the server 410 via the network 230. The client device 405 may include an agent 406. The agent 406 may determine text portions in the content item 411 to translate according to the translation policy 413. The agent 406 may determine if the translation policy 413 defines one or more rules for the content item that was received from the server 410. The agent 406 may parse the content item 411 to determine what portions of the content item are text portions. The agent 406 may determine if the text portions correspond to rules in the translation policy 413. For example, if the content item 411 is a webpage in Hypertext Markup Language (HTML), the agent 406 may parse the HTML (e.g., traverse the HTML tree structure) and identify HTML tags that match text portions 504 indicated by the translation policy 413. The agent 406 may determine a user of the client device 405. For example, a user may be required to sign in to the client device 405 or an application executing on the client device 405. The agent 406 may determine what rules in the translation policy 413 apply to the user and may ignore rules that do not apply to the user (e.g., rules in which the user ID 512 in policy 413 does not match the user) of the device 405. The agent 406 may determine the target language that the text portions should be translated into based on the translation policy 413 (e.g., based on the target language 506 indicated in a rule). The agent 406 may be a plugin (e.g., a software add-on that enhances the capabilities of a program) to a web browser, mobile application, or other program.

The client device 405 may send requests to the server 410 for one or more text portions in the content items 411 to be translated. For example, the agent 406 may send, to the translation engine indicated by the translation policy 413, a request containing the text portions to be translated and a target language that the text should be translated into. A request for translation may include information identifying a user (e.g., a user ID). A request for translation may include an indication of which portions of the content item should be translated. A request may identify particular paragraphs, sections, sentences, words, and/or letters within text of the content item to be translated. For example, the content item 411 may be a website. The request for translation may identify text within particular HTML tags of the website to be translated (e.g., text within all <p> tags nested under <div> tags that have the class “ctx-comment”).

FIG. 6 depicts an illustrative flow diagram for translation of text portions of a content item. Although one or more steps of the example method 600 of FIG. 6 are described for convenience as being performed by the client device 405, one, some, or all of such steps may be performed by one or more other devices including the server 410 or any device described in FIGS. 1-5. One or more steps of the example method 600 of FIG. 6 may be rearranged, modified, repeated, and/or omitted.

At step 605, the client device 405 may request a content item (e.g., the content item 411) from the server 410. For example, a user of the client device 405 may wish to read or view the content item. The client device 405 may send the request via the computer network 230. At step 608, the client device 405 may request the translation policy 413 from the server 410 (e.g., via the computer network 230). The client device 405 may request a portion of the translation policy 413. For example, the client device 405 may request the portion of the translation policy 413 that applies to a current user of the client device 405. The client device 405 may request the portion of the translation policy 413 that applies to the content item requested by the client device 405 in step 605.

At step 611, the client device 405 (e.g., the agent 406 executing on the client device 405) may determine the text portions of the content item 411. The client device 405 may determine the locations of text within the content item 411. For example, if the content item 411 is a web page in HTML, the content item 411 may have pictures, video, and text. The client device 405 may parse the HTML for HTML tags that indicate text (e.g., <p>, <span>, etc.). The client device 405 may analyze content within the HTML tags to determine if text is present (e.g., by determining whether the content contains alphanumeric characters).

At step 614, the client device 405 may generate user interface elements for text portions within the content item 411. For example, the client device 405 may generate buttons to link with text portions within the content item. If the content item 411 is a webpage, the client device 405 may modify the code of the page (e.g., HTML, CSS, Javascript, etc.) so that the user interface elements are displayed near (e.g., adjacent to, above, below, etc.) their corresponding text portions of the content item 411. A user may interact with a user interface element (e.g., by clicking or tapping a user interface element) to indicate that the text portion linked with the user interface element should be translated.

At step 616, whether the content item 411 corresponds to the translation policy 413 may be determined. The content item 411 may have a translation policy 413 that indicates what portions of the content item to translate. If a portion of the translation policy 413 corresponds to the content item 411, then step 617 may be performed. If it is determined that the content item 411 does not have matching translation policy then step 626 may be performed.

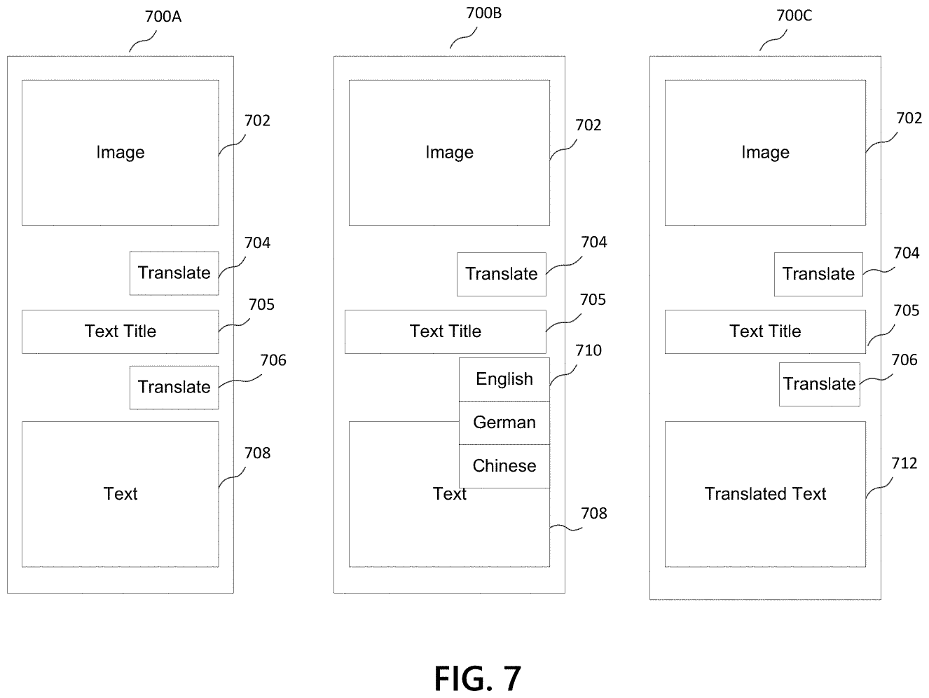

At step 617, whether one or more translation menus should be generated may be determined. A translation menu may be a user interface element that allows a user to select a language for a text portion to be translated into. The translation menu is discussed in more detail below in connection with FIG. 7. The client device 405 (e.g., the agent 406 executing on the client device 405) may analyze the translation policy 413 to determine whether any portions of text of the content item 411 have multiple target languages 506. If any text portion has multiple target languages, the client device 405 may determine that one or more translation menus should be generated. If no text portions have multiple target languages, the client device 405 may determine that no translation menus should be generated.

At step 618, the client device 405 may generate one or more translation menus according to the translation policy 413 for the content item 411. For example, a translation menu may be generated for teach text portion that has more than one target language. The user device 405 may add the translation menu to the content item 411 so that a user can interact with the menu. For example, if the content item 411 is a webpage, the user device 405 may modify the code of the webpage (e.g., HTML, CSS, Javascript, etc.) so that the translation menu is displayed near (e.g., adjacent, above, below, etc.) the corresponding text portion.

At step 620, the client device 405 may determine text portions within the content item 411 that should be translated. The client device 405 (e.g., the agent 406 executing on the client device) may parse the text of the content item 411 to determine text portions that match the text portions indicated by the translation policy 413. For example, the content item 411 may be a webpage in HTML. The translation policy 413 may indicate that text within <div> elements with the class “ctx-body” should be translated into Spanish for a particular user. The client device 405 may iterate through each element of the HTML for the content item 411 to determine which parts of the HTML match the translation policy 413. As an additional example, the translation policy 413 may indicate that the first sentence of each paragraph should be translated into a target language. The client device 405 may parse the text (e.g., using regular expressions, neural networks, etc.) to determine the first sentence of each paragraph in the content item 411.

At step 623, the client device 405 may cause the text portions determined in step 620 to be translated. The client device 405 may cause the text portions to be translated according to the translation policy 413. For example, if the translation policy 413 indicates that a text portion should be translated locally, the client device 405 may translate the text portion into the corresponding target language 506 (e.g., using the local translator 407). If the translation policy 413 indicates that a text portion should be translated remotely, the client device 405 may send a request containing the text portion and an indication of the target language to the remote translator 412 to be translated. For example, the remote translator 412 may be able to generate a more accurate translation than the local translator (e.g., through the use of more complicated machine learning models, more processing power, etc.). The remote translator 412 may translate the text and send it back to the client device 405 for output or display.

Step 626 may be performed if it is determined that there is no translation policy that corresponds to the content item 411. At step 626, the client device 405 may use the local translation module 408 to determine which text portions of the content item 411 to translate. For example, the translation module 414 may take as input the content item 411 (or each text portion of the content item 411) and may output which text portions should be translated. The translation module 408 may use machine learning techniques to make its determinations (as described above in connection with FIG. 4).

At step 632, the client device 405 may receive one or more translation requests from a user of the client device 405. The user may use the user interface elements generated in step 614 to indicate text portions that the user wants to be translated. The user may use the user interface elements to select one or more paragraphs, sentences, words, etc. to be translated. The user may use the user interface elements to select a language that each text portion should be translated into. Alternatively, the user may have a default language (e.g., indicated by a target language 506 in the translation policy 413) that may be used as the language to translate the text into.

At step 635, whether the local translator should be used to translate the text portions indicated by the translation requests and/or the text portions determined in step 626 may be determined. The client device 405 (e.g., the agent 406 executing on the client device 405) may determine to use the local translator 407 if a network connection quality (e.g., bandwidth, throughput, etc.) is below a threshold. For example, if the client device 405 is unable to connect to the server 410 then the local translator 407 may be used. Alternatively, if the connection quality is above a threshold, the client device 405 may determine to use the remote translator 412. The remote translator 412 may have greater processing power and may be able to translate the text portions more quickly. The remote translator 412 may use more processing power and may be able to generate a more accurate translation than the local translator. If the amount of text to be translated exceeds a threshold then the client device 405 may determine that the remote translator 412 should be used. For example, the client device 405 may determine that using the local translator will take too long (e.g., more than 1 second, more than 3 seconds, more than 10 seconds, etc.) to translate the text portions.

If it is determined, in step 635, that the local translator should not be used, step 638 may be performed. At step 638, the text portions determined in step 626 and/or the text portions requested in step 632 may be translated by the remote translator 412. The client device 405 may send the text portions and the target languages to the remote translator 412 for translation. The remote translator 412 may translate the text portions into the corresponding target languages and send the translated text to the client device 405. If it is determined, in step 635, that the local translator should be used, step 641 may be performed. At step 641, the text portions determined in step 626 and/or the text portions requested in step 632 may be translated by the local translator 407.

At step 644, training data may optionally be generated by the client device 405 and/or the server 410. The training data may the same as or similar to the training data discussed above in connection with FIG. 4. The training data may be used to improve the module 414. For example, the training data may be used to train a machine learning model to determine which text portions within a content item should be translated. The training data may include the translation requests received in step 632. For example, the training data may have one or more text portions that are labeled with an indication of whether the text portion was requested to be translated or not. The training data may include the user ID and/or demographic information (age, gender, geographic location, etc.) of the user that requested the text portion to be translated. At step 647, a translation model (e.g., a machine learning model) may be trained by the module 414. The translation module 414 may generate and/or train the model (or machine learning model) as described above in connection with FIG. 4.

At step 651, whether the translation policy 413 should be updated may be determined. The translation module 414 may be used to determine whether the translation policy 413 should be updated. The translation module 414 may use a machine learning model and may take as input a content item and may output an indication of which portions of text within the content item should be translated. The output may include an identification of the content item, one or more portions of text to be translated, a target language for each portion of text to be translated, whether the text portion should be translated locally or remotely, and/or which users each text portion should be translated for. For example, a content item may have a corresponding current translation policy. After training the translation model in step 647, the module 414 may output the text or indications of the text (e.g., the locations where the text can be found in the content item) to be translated for one or more content items, users, etc. If the output indicates differences from the policy 413, then it may be decided (e.g., by the server 410 or the client device 405) to update the translation policy 413. For example, output from the translation module 414 may indicate that text portions different from what is currently indicated by the translation policy 413 should be translated (e.g., because a number of users above a threshold requested the text portion to be translated). The output may indicate that a particular user prefers some portions of text (e.g., titles of a document, captions for graphs and pictures, etc.) to be translated into a first language and other portions of text (e.g., paragraphs) to be translated into a second language. The output may indicate that users below an age threshold prefer some portions of text to be translated and users above the age threshold prefer other portions of text to be translated within a content item. The output may indicate that users in a first geographic location (e.g., neighborhood, city, state, county, country, zip code, etc.) prefer some portions of text to be translated while users in a second geographic location prefer other portions of text to be translated.

Additionally or alternatively, the translation policy 413 may be modified by a user. For example, a user may identify text portions within a content item and may create a translation policy for those text portions. At step 654, the translation policy 413 may be changed (e.g., by the user device 405 or the server 410) according to the output of the translation module 414 and/or according to changes made by a user. If it is determined that there is no update to the translation policy in step 651, step 605 may be performed and the method 600 may be repeated.

FIG. 7 depicts multiple forms 700A-700C of an illustrative user interface in which the translation system of the present disclosure can be applied to translate content of the interface (e.g., as described in FIGS. 4-6). Forms 700A-700C contain the same content item (e.g., a webpage). The content item includes an image 702, a text portion 705, and a text portion 708. The text portion 708 may be any text portion described above in connection with FIGS. 1-6. Forms 700A-700C displayed within the user interface contain user interface (UI) elements 704 and 706. A user may interact with the UI element 704 to request the text portion 705 be translated. A user may interact with the UI element 706 to request the text portion 708 be translated. A user may have a default target language for translation. A text portion may be translated into the default target language in response to the user interacting with the UI element 704 or UI element 706.

After a user interacts with UI element 706, the user interface may change from display of form 700A to a display of form 700B. UI element 706 may change into UI element 710 which displays a translation menu. The UI element 710 may indicate one or more languages for selection by a user. The languages may be indicated in written form as shown in form 700B (e.g., English, German, Chinese, etc.). Alternatively, a language may be indicated by a flag of a country that speaks the language (e.g., the Italian flag for the Italian language). After a user selects a language from the UI element 710, the text corresponding to the UI element 710 may be translated (as discussed in more detail above in FIGS. 1-6) and form 700C may be displayed in place of form 700B. The text portion 708 may be replaced with the translated text portion 712. The UI element 706 may be displayed in place of the UI element 710.

The following paragraphs (M1) through (M7) describe examples of methods that may be implemented in accordance with the present disclosure.

(M1) A method comprising receiving, by a computing device, content of a webpage, the content including text in a first language; determining, by the computing device, a subset of text of the received content to translate into a second language different from the first language based on a location of the subset of text within the webpage and an identifier of the subset of text, the identifier indicates that portion of text of the received content in which to translate; translating, by the computing device, the determined subset of text into a second language; and providing, by the computing device, the translated subset of text for display within a browser of the computing device so that a portion of the webpage that is of interest to a user of the computing device appears translated in the second language.

(M2) A method may be performed as described in paragraph (M1) wherein the subset of text is determined based on preferences of the user.

(M3) A method may be performed as described in paragraph (M2) further comprising receiving user input indicating a second subset of text of the received content to translate into the second language; and updating the user preferences based on the user input.

(M4) A method may be performed as described in any of paragraphs (M1) through (M3) further comprising: receiving user input indicating a second subset of text of the received content to translate into the second language; and generating, based on the user input, training data for use in a machine learning model for determining text to translate.

(M5) A method may be performed as described in any of paragraphs (M1) through (M4) wherein the translating comprises: based on determining that a network connection quality fails to satisfy a threshold, translating the subset of text by the computing device

(M6) A method may be performed as described in any of paragraphs (M1) through (M5) wherein the translating comprises: based on determining that a network connection quality satisfies a threshold, sending the subset of text to a server for translation.

(M7) A method may be performed as described in any of paragraphs (M1) through (M6) further comprising: determining, based on user input, the second language from a plurality of languages, wherein the plurality of languages are indicated by translation preference data associated with the use.

The following paragraphs (A8) through (A14) describe examples of apparatuses that may be implemented in accordance with the present disclosure.

(A8) An apparatus comprising at least one processor; and memory storing computer-readable instructions that, when executed by the at least one processor, cause the apparatus to: receive content of a webpage, the content including text in a first language; determine a subset of text of the received content to translate into a second language different from the first language based on a location of the subset of text within the webpage and an identifier of the subset of text, the identifier indicates that portion of text of the received content in which to translate; cause translation of the determined subset of text into a second language; and providing the translated subset of text for display within a browser of the apparatus so that a portion of the webpage that is of interest to a user of the apparatus appears translated in the second language.

(A9) An apparatus as described in paragraph (A8) wherein the subset of text is determined based on user preferences indicating the subset of text.

(A10) An apparatus as described in any of paragraphs (A8) through (A9) wherein the memory, when executed by the at least one processor, further cause the apparatus to: receive user input indicating a second subset of text of the received content to translate into the second language; and update translation preference data based on the user input.

(A11) An apparatus as described in any of paragraphs (A8) through (A10) wherein the memory, when executed by the at least one processor, further cause the apparatus to: receive user input indicating a second subset of text of the received content to translate into the second language; and generate, based on the user input, training data for use in a machine learning model for determining text to translate.

(A12) An apparatus as described in any of paragraphs (A8) through (A11) wherein the causing translation comprises: based on determining that a network connection quality fails to satisfy a threshold, translating the subset of text by the apparatus.

(A13) An apparatus as described in any of paragraphs (A8) through (A12) wherein the causing translation comprises: based on determining that a network connection quality satisfies a threshold, sending the subset of text to a server for translation.

(A14) An apparatus as described in any of paragraphs (A8) through (A13) wherein the memory, when executed by the at least one processor, further cause the computing device to determine, based on user input, the second language from a plurality of languages, wherein the plurality of languages are indicated by translation preference data associated with the user.

The following paragraphs (M15) through (M20) describe examples of methods that may be implemented in accordance with the present disclosure.

(M15) A method comprising receiving, by a computing device, content of a webpage, the content including text in a first language; determining, by the computing device, a subset of text of the received content to translate into a second language different from the first language based on output from a machine learning model, the output indicates a location of the subset of text within the webpage; translating, by the computing device, the determined subset of text into a second language; and providing, by the computing device, the translated subset of text for display within a browser of the computing device so that a portion of the webpage that is of interest to a user of the computing device appears translated in the second language.

(M16) A method may be performed as described in paragraph (M15) wherein the subset of text is determined based on preferences of the user.

(M17) A method may be performed as described in any of paragraphs (M15) through (M16) further comprising receiving user input indicating a second subset of text of the received content to translate into the second language; and updating translation preference data based on the user input.

(M18) A method may be performed as described in any of paragraphs (M15) through (M17) further comprising receiving user input indicating a second subset of text of the received content to translate into the second language; and generating, based on the user input, training data for training the machine learning model to determine text to translate.

(M19) A method may be performed as described in any of paragraphs (M15) through (M18) wherein the translating comprises: based on determining that a network connection quality fails to satisfy a threshold, translating the subset of text by the computing device.

(M20) A method may be performed as described in any of paragraphs (M15) through (M19) wherein the translating comprises: based on determining that a network connection quality satisfies a threshold, sending the subset of text to a server for translation.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method comprising:
receiving, by a computing device, content of a webpage, the content including text in a first language;
determining, by the computing device, a subset of text of the received content to translate into a second language different from the first language based on a location of the subset of text within the webpage and an identifier of the subset of text, the identifier indicates that portion of text of the received content in which to translate;
translating, by the computing device, the determined subset of text into a second language; and
providing, by the computing device, the translated subset of text for display within a browser of the computing device so that a portion of the webpage that is of interest to a user of the computing device appears translated in the second language.

2. The method of claim 1, wherein the subset of text is determined based on preferences of the user.

3. The method of claim 2, further comprising:
receiving user input indicating a second subset of text of the received content to translate into the second language; and
updating the user preferences based on the user input.

4. The method of claim 1, further comprising:
receiving user input indicating a second subset of text of the received content to translate into the second language; and
generating, based on the user input, training data for use in a machine learning model for determining text to translate.

5. The method of claim 1, wherein the translating comprises:
based on determining that a network connection quality fails to satisfy a threshold, translating the subset of text by the computing device.

6. The method of claim 1, wherein the translating comprises:
based on determining that a network connection quality satisfies a threshold, sending the subset of text to a server for translation.

7. The method of claim 1, further comprising:
determining, based on user input, the second language from a plurality of languages, wherein the plurality of languages are indicated by translation preference data associated with the user.

8. A computing device comprising:
at least one processor; and
memory storing computer-readable instructions that, when executed by the at least one processor, cause the computing device to:
receive content of a webpage, the content including text in a first language;
determine a subset of text of the received content to translate into a second language different from the first language based on a location of the subset of text within the webpage and an identifier of the subset of text, the identifier indicates that portion of text of the received content in which to translate;
cause translation of the determined subset of text into a second language; and
providing the translated subset of text for display within a browser of the computing device so that a portion of the webpage that is of interest to a user of the computing device appears translated in the second language.

9. The computing device of claim 8, wherein the subset of text is determined based on user preferences indicating the subset of text.

10. The computing device of claim 8, wherein the memory, when executed by the at least one processor, further cause the computing device to:
receive user input indicating a second subset of text of the received content to translate into the second language; and
update translation preference data based on the user input.

11. The computing device of claim 8, wherein the memory, when executed by the at least one processor, further cause the computing device to:
receive user input indicating a second subset of text of the received content to translate into the second language; and
generate, based on the user input, training data for use in a machine learning model for determining text to translate.

12. The computing device of claim 8, wherein the causing translation comprises:
based on determining that a network connection quality fails to satisfy a threshold, translating the subset of text by the computing device.

13. The computing device of claim 8, wherein the causing translation comprises:
based on determining that a network connection quality satisfies a threshold, sending the subset of text to a server for translation.

14. The computing device of claim 8, wherein the memory, when executed by the at least one processor, further cause the computing device to:
determine, based on user input, the second language from a plurality of languages, wherein the plurality of languages are indicated by translation preference data associated with the user.

15. A method comprising:
receiving, by a computing device, content of a webpage, the content including text in a first language;
determining, by the computing device, a subset of text of the received content to translate into a second language different from the first language based on output from a machine learning model, the output indicates a location of the subset of text within the webpage;
translating, by the computing device, the determined subset of text into a second language; and
providing, by the computing device, the translated subset of text for display within a browser of the computing device so that a portion of the webpage that is of interest to a user of the computing device appears translated in the second language.

16. The method of claim 15, wherein the subset of text is determined based on preferences of the user.

17. The method of claim 15, further comprising:
receiving user input indicating a second subset of text of the received content to translate into the second language; and
updating translation preference data based on the user input.

18. The method of claim 15, further comprising:
receiving user input indicating a second subset of text of the received content to translate into the second language; and
generating, based on the user input, training data for training the machine learning model to determine text to translate.

19. The method of claim 15, wherein the translating comprises:
based on determining that a network connection quality fails to satisfy a threshold, translating the subset of text by the computing device.

20. The method of claim 15, wherein the translating comprises:
based on determining that a network connection quality satisfies a threshold, sending the subset of text to a server for translation.
